(19) United States
(12) Patent Application Publication
(10) Pub. No.: US 2011/0077021 A1
(43) Pub. Date: Mar. 31, 2011

(54) PROVIDING A LAST-SEEN MOBILE UNIT LOCATION TO A LOCATION BASED SERVICE

(76) Inventors: Semyon B. Mizikovsky, Morganville, NJ (US); Zhibi Wang, Woodridge, IL (US)

(21) Appl. No.: 12/570,489

(22) Filed: Sep. 30, 2009

(51) Int. Cl. H04W 64/00

(52) U.S. Cl. 455/456.1

(57) ABSTRACT

The present invention provides a method involving a mobile unit, a location server, a location-based application client, and a location-based application server configured to provide location-based applications. The method includes receiving, at the location server and from the location-based application server, a request from location-based application client for a current location of the mobile unit and attempting, at the location server, to determine the current location of the mobile unit. The method also includes providing, from the location server to the location-based application server, information indicating a previous location of the mobile unit when the attempt to determine the current location of the mobile unit is unsuccessful.

### BACKGROUND OF THE INVENTION

1. Field of the Invention

This invention relates generally to communication systems, and, more particularly, to wireless communication systems.

2. Description of the Related Art

Wireless communication systems use an interconnected network of base stations to provide wireless connectivity to mobile units over an extended geographic area. Each base station is responsible for providing wireless connectivity to mobile units within a particular portion of the geographic area and the portion served by each base station is often referred to as a cell. Hand off between the base stations allows mobile units to move within and between the cells in the extended geographic area without worrying about interruptions in ongoing calls or dropped calls. The roaming range of a mobile unit is limited only by the availability and accessibility of compatible interconnected base stations. Current wireless communication systems typically allow mobile units to move freely within individual countries and/or within multiple contiguous countries. Future developments in networking and the deployment of additional base stations should eventually support intercontinental and even worldwide roaming capabilities for individual mobile units.

One challenge facing extended wireless communication systems is to keep track of the location of all of the mobile units supported by the system. Conventional wireless communication systems address this problem by implementing various tracking techniques that include requiring mobile units to provide location update information as they roam through different cells within the wireless communication system. The wireless communication system can page mobile units to determine their current location. The location of the mobile units may also be determined and/or refined using signal delay and/or triangulation techniques and/or GPS technology.

Service providers can leverage the availability of location information to provide applications and/or services based upon the location of the mobile unit. These services are generally known as location-based services and exemplary location-based services include mapping, providing directions from a current location to another location, recommending attractions near a user's current location, dispatching emergency services to the user's current location, and the like. Location-based services are typically provided to a mobile unit by a location-based application server that communicates with a location server located in the mobile unit's home network. For example, the location-based application server may request the location of the mobile unit from the location server. In response to the request, the location server collaborates with other network elements to coordinate the measurement and calculate the mobile unit's location, e.g., by collecting information on the mobile unit. If the location server successfully locates the mobile unit, it delivers the location of the mobile unit to the location-based application server, which may then use this location to provide the location-based service to the mobile unit or other location service client.

In many circumstances, the location server may not be able to locate the mobile unit. For example, the location server may not be able to locate the mobile unit if the mobile unit has powered off or the mobile unit has moved out of the radio coverage area of the wireless communication system. Since the location server is unable to determine where the mobile unit is located, the location server returns an error message to the location-based application server in response to the request from the location-based application server. In that situation, the location-based application server will not able to provide the location-based service without any knowledge of the location of the mobile unit.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided involving a mobile unit, a location server, and a location-based application server configured to provide location-based applications. The method includes receiving, at the location server and from the location-based application server, a request for a current location of the mobile unit and attempting, at the location server, to determine the current location of the mobile unit. The method also includes providing, from the location server to the location-based application server, information indicating a previous location of the mobile unit when the attempt to determine the current location of the mobile unit is unsuccessful.

In another embodiment, a method is provided involving a mobile unit, a location server, and a location-based application server configured to provide location-based applications. The method includes providing, to the location server and from the location-based application server, a request for a current location of the mobile unit. The method also includes receiving, at the location-based application server and from the location server, information indicating a previous location of the mobile unit when the location server is unable to determine the current location of the mobile unit.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates one exemplary embodiment of a message that can be transmitted from a location server to a location-based application server; and

FIG. 3 conceptually illustrates one exemplary embodiment of a method of providing a last-seen location of a mobile unit to a location-based application server.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

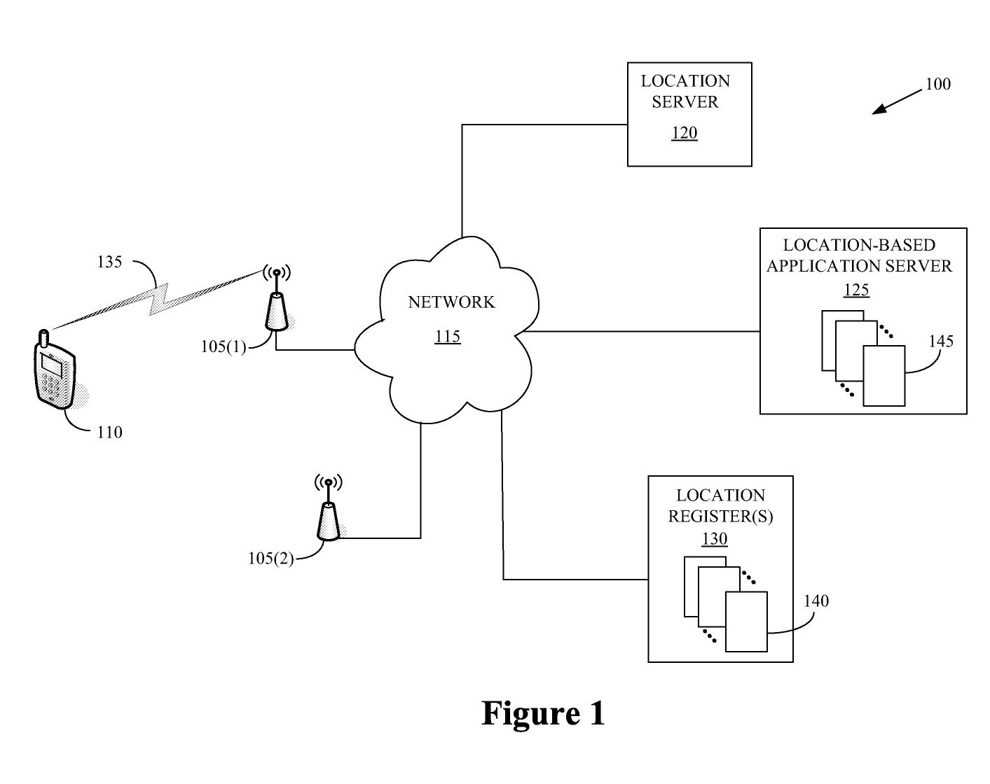

FIG. 1 conceptually illustrates one exemplary embodiment of a wireless communication system 100. In the illustrated embodiment, the wireless communication system 100 includes multiple base stations 105 that are used to provide wireless connectivity to one or more mobile units 110. The wireless communication system 100 may include any number of base stations 105 and/or mobile units 110. Although the term “base station” is used throughout the present application, persons of ordinary skill in the art having benefit of the present disclosure should appreciate that this term may refer to various elements that are used to provide wireless connectivity including base station routers, node-Bs, access points, and the like. Similarly, the “mobile unit” described herein may be a mobile phone, a smart phone, a network interface card, a laptop computer, a desktop computer, and the like. Wireless connectivity may be provided according to any combination of standards and/or protocols and in the interest of clarity only those aspects of the wireless communication standards and/or protocols that are relevant to the claimed subject matter will be discussed herein.

The base stations 105 are communicatively coupled to a network 115, which may include wired and/or wireless interconnections. The network 115 permits the base stations 105 to communicate with various elements of the wireless communication system 100 according to well known techniques. In the illustrated embodiment, the base stations 105 are in communication with various servers that are used to support the provision of location-based services to the mobile units 110. The term “location-based service” is used herein to refer to any service or application implemented in the wireless communication system 100 that utilizes a location of the mobile unit 110. Exemplary location-based services include, but are not limited to, mapping, providing directions from a current location to another location, recommending attractions near a user's current location, dispatching emergency services to the user's current location, tracking lost people, location based information such as finding restaurants near a certain location, and equipment tracking. In the illustrated embodiment, the servers include a location server 120, a location-based application server 125, and one or more location registers 130 such as a home location register (HLR), a visitor location register (VLR), an authentication, authorization, and accounting server (HAAA), a home agent (HA), and the like. These entities may be implemented in separate physical devices or combined in one or more physical devices.

The mobile unit 110 initially establishes communication with the wireless communication system 100 over an air interface 135. Once the mobile unit 110 has registered and/or connected to the system 100, wireless communication system 100 attempts to keep track of the location of the mobile unit 110. For example, the mobile unit 110 may report its current location or location measurement to the network whenever it is requested from the network or triggered by some event or timer, and the like. This location-related information may then be conveyed to the location registers 130 for storage. In the illustrated embodiment, the location-related information associated with each mobile unit 110 in the wireless communication system 100 is stored in a record 140 that is maintained at the location register 130. Exemplary information that may be stored in the records 140 includes, but is not limited to, network system identifiers, location coordinates of the mobile unit 110, an estimate of an accuracy of the location coordinates, and a time when the location coordinates were registered with the location register 130.

In the illustrated embodiment, the mobile unit 110 has subscribed and/or registered for one or more location-based services provided by the location-based application server 125. The location-based services are provided by one or more location-based applications 145 that are implemented by the location-based application server 125. The location-based services may be requested by and/or provided to a location-based client, which is a physical and/or logical entity implemented in hardware, firmware, and/or software. In one embodiment, the location-based client is implemented in the mobile unit 110 and so the mobile unit 110 and the location-based client may be considered synonymous. Alternatively, the location-based client may be implemented outside of the mobile unit 110 may then provide information associated with the location-based service to the mobile unit 110. For example, the location-based client may be implemented in an emergency center that provides the mobile location to the law enforcement personnel.

The user of the mobile unit 110 and the service provider have agreed that a last-seen location of the mobile unit 110 can be provided to the location-based application server 125 if the location server 120 is unable to locate the mobile unit 110. The last-seen location may be the actual location of the mobile unit 110 at a time prior to a request for the current location of the mobile unit 110 or, alternatively, the last-seen location may be an estimate of the location made using information acquired prior to the request for the current location. The agreement may be negotiated between the user and the service provider as part of a service agreement and/or part of an agreement for providing the location-based services. In one embodiment, this agreement may apply to all of the applications 145 associated with the mobile unit 110. Alternatively, this agreement may apply to selected applications 145 so that the last-seen location may be provided to the selected location-based applications 145 when these applications 145 request the current location of the mobile unit 110 and the location server 120 is unable to determine the current location.

A request for a location-based application may then be received at the location-based application server 125. In one embodiment, this request comes from the mobile unit 110 via the network 115. Alternatively, the request may come from other entities via the network 115. For example, the user may have described or been registered for an emergency service that allows the wireless communication system 100 to locate the mobile unit 110 in case of emergency. The request for the emergency service may be generated by the mobile unit 110 or by other entities such as systems operated by the fire department, the police department, an ambulance service, and the like. The location-based application server 125 may then initiate an application 145 and request location information indicating the current location of the mobile unit 110. This request is provided to the location server 120, which attempts to locate the mobile unit 110. Techniques for locating the mobile unit 110, such as GPS or triangulation, are known in the art and will not be discussed in detail herein.

In the event that the location server is unable to determine the current location of the mobile unit 110, the location server 120 can acquire a last-seen location of the mobile unit 110. In the illustrated embodiment, the location server 120 sends a request to the location registers 130 for an estimated or stored value of the last-seen location of the mobile unit 110. The location registers 130 can then access, calculate, and/or estimate the last-seen location of the mobile unit 110 using information stored by the location registers 130. The stored information may include a network system identifier, location coordinates of the mobile unit 110, an estimate of an accuracy of the location coordinates, a time when the location coordinates were registered with the location registers 130, and the like. The location register 130 returns the value of the last-seen location of the mobile unit 110 to the location server 120, which then forwards this information to the location-based application server 125 so that the server 125 can use this information to provide the location-based service.

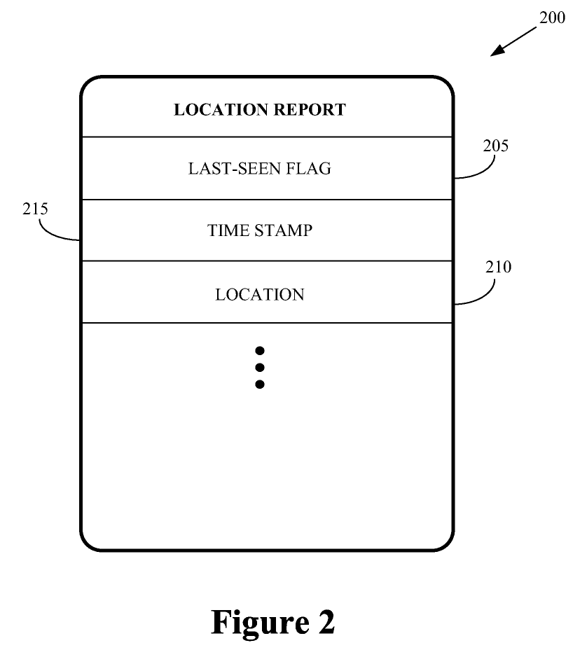

FIG. 2 conceptually illustrates one exemplary embodiment of a message 200 that can be transmitted from the location server 120 to the location-based application server 125. In the illustrated embodiment, the message 200 is a location report that includes a last-seen flag 205, a location 210, and (optionally) a timestamp 215 that indicates a time at which the location 210 was determined. In various alternative embodiments, the message 200 may also include other information not depicted in FIG. 2. If the location server 120 successfully determines the current location of the mobile unit 110 in response to the request from the location-based application server 125, then the last-seen flag 205 is set to a value (such as 1) that indicates that the location information 210 included in the location report refers to the current location of the mobile unit 110. However, if the location server 120 is not able to successfully determine the current location of the mobile unit 110, then the last-seen flag 205 is set to a value (such as 0) that indicates that the location information 210 refers to a last-seen location of the mobile unit 110.

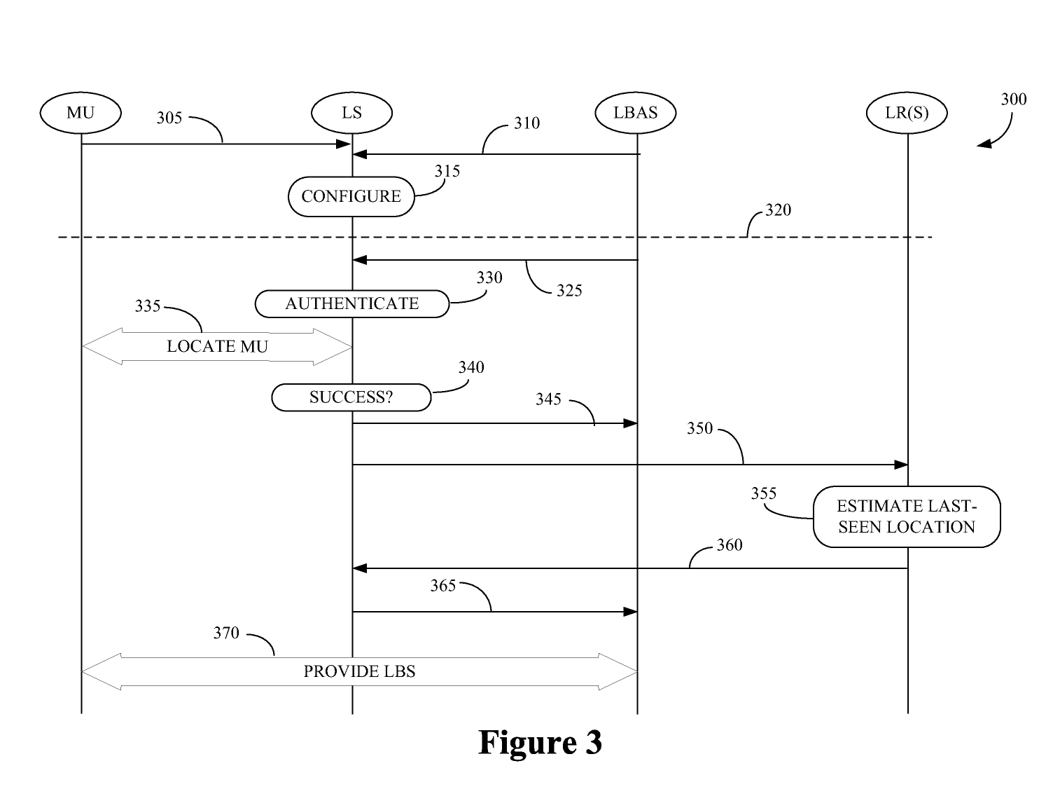

FIG. 3 conceptually illustrates one exemplary embodiment of a method 300 of providing a last-seen location of a mobile unit (MU) to a location-based application server (LBAS). The method 300 begins by establishing that a last-seen location can be provided when the mobile unit cannot be located response to a request from the location-based application server. For example, the mobile user may sign up for a service agreement with a location-based service (LBS) application service provider and agree that the mobile last-seen-location will be provided to the LBS application when the mobile position or location cannot be provided and/or when the mobile unit cannot be located due to mobile unit being in the power-off state, the mobile unit not being in the radio coverage area of the wireless communication system, or in other circumstances.

In the illustrated embodiment, the mobile unit (or an associated location-based client) can provide (at 305) a signal or information to the location server (LS) informing the location server that the last-seen location information should be provided if the location server is unable to locate the mobile unit. The location-based application server may also provide (at 310) a signal or information to the location server informing the location server that the last-seen location information should be provided if the location server is unable to locate the mobile unit. In various alternative embodiments, either of the steps 305 and 310 may be performed (and the other not performed) or both steps 305 and 310 may be performed. The location server may then be configured (at 315) to provide the last-seen location. For example, a flag associated with the mobile unit may be set (at 315) in the location server to indicate that the location server is to provide the last-seen location when it is unable to locate the mobile unit.

At this point, which is indicated by the dashed line 320, the system is configured to allow the last-seen location to be provided when necessary. The wireless communication system then begins to (or continues to) keep track of the location of the mobile unit as it moves throughout the wireless communication system. For example, in the mobile network, whenever the mobile unit performs location related activities, such as when the mobile unit's location is requested by the location server, an access registration, location update, de-registration, power-on, power-off, and the like, the location of the mobile unit may be registered with the network location register. In one embodiment, the location register may be a collection of network elements that include, but are not limited to, the location server, the HLR, the HAAA, and the HA associated with the mobile unit.

The location-based application server then requests (at 325) location information to be used by a location-based application. For example, the location-based application server may request (at 325) the current mobile unit location from the location server. The location server then performs (at 330) authentication and authorization of the location-based service application to ensure that this application is authentic and is authorized to obtain the mobile units location. If the application is successfully authenticated and authorized, the location server attempts (at 335) to locate the mobile unit using conventional techniques such as GPS and triangulation. Although the attempt (at 335) is depicted in FIG. 3 as a link between the location server and the mobile unit, persons of ordinary skill in the art having benefit of the present disclosure should appreciate that the location server may not be in direct communication with the mobile unit when it attempts to locate (at 335) the mobile unit. For example, the location server may attempt to locate (at 335) the mobile unit by sending requests to other entities such as base stations that may be in direct communication with the mobile unit.

The location server then determines (at 340) whether or not the location of the mobile unit has been successfully determined. If the location server has determined the current location of the mobile unit, then the location server returns (at 345) the current location to the location-based application server. In one embodiment, the returned message includes a flag indicating that the location server has successfully determined the current location of the mobile unit. However, if the location server has not successfully determined the current location of the mobile unit, then the location server sends (at 350) a request for a last-seen location to the location register. This request may include an identifier of the mobile unit such as an International Mobile Subscriber Identity or other identifying information that allows the location register to determine the identity of the mobile unit.

The location register may then estimate (at 355) the last-seen location of the mobile unit. In one embodiment, the location register collects location information from various sources and processes information to best reflect the mobile last-seen-location. The collected information may include, but is not limited to, the network system ID, location coordinates, accuracy, and the time when the location was registered. The location register then returns (at 360) the last-seen location to the location server, which provides (at 365) this information to the location-based application server. For example, the location server may transmit a message including the location information, a timestamp associated with the location information, and a flag indicating that the location information and the timestamp refer to a last-seen location of the mobile unit because the location server was unable to locate the current location of the mobile unit. The location-based application service may then use the provided location information to provide (at 370) the location-based service or application to the mobile unit and/or the associated location-based client.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method involving a mobile unit, a location server, and a location-based application server configured to provide location-based applications, comprising:
receiving, at the location server and from the location-based application server, a request for a current location of the mobile unit;
attempting, at the location server, to determine the current location of the mobile unit; and
providing, from the location server to the location-based application server, information indicating a previous location of the mobile unit when the attempt to determine the current location of the mobile unit is unsuccessful.

2. The method of claim 1, comprising determining the previous location of the mobile unit prior to receiving the request for the current location of the mobile unit and storing information indicating the previous location in a location register.

3. The method of claim 2, wherein storing the information indicating the previous location of the mobile unit comprises storing information indicating a time at which the previous location was determined by the location server.

4. The method of claim 2, wherein providing information indicating the previous location of the mobile unit comprises:
authenticating, at the location server, the location-based application server;
requesting, at the location server, the previous location from the location register in response to authenticating the location-based application server; and
receiving, at the location server, the previous location from the location register.

5. The method of claim 4, wherein receiving the previous location comprises receiving a previous location estimated by the location register using at least one of a network system identifier, location coordinates of the mobile unit, an estimate of an accuracy of the location coordinates, and a time when the location coordinates were registered with the location register.

6. The method of claim 1, wherein providing the information indicating the previous location of the mobile unit comprises providing a message including a flag indicating that the location server was unable to determine the current location of the mobile unit.

7. The method of claim 1, comprising receiving, at the location server and from the location-based application server, a request to receive the previous location when the location server is unable to determine the current location of the mobile unit, wherein the request to receive the previous location is received prior to receiving the request for the current location of the mobile unit.

8. The method of claim 7, comprising configuring the location server to provide the previous location when the location server is unable to determine the current location of the mobile unit, the configuration being performed in response to receiving the request to receive the previous location when the location server is unable to determine the current location of the mobile unit.

9. A method involving a mobile unit, a location server, and a location-based application server configured to provide location-based applications, comprising:
providing, to the location server and from the location-based application server, a request for a current location of the mobile unit; and
receiving, at the location-based application server and from the location server, information indicating a previous location of the mobile unit when the location server is unable to determine the current location of the mobile unit.

10. The method of claim 9, wherein receiving the information indicating the previous location comprises receiving information indicating a previous location determined prior to the location-based application server providing the request for the current location of the mobile unit.

11. The method of claim 10, wherein receiving information indicating the previous location of the mobile unit comprises:
authenticating the location-based application server to the location server;
receiving, at the location-based application server, the previous location from the location server in response to successful authentication of the location-based application server, and wherein the location server has retrieved the previous location from a location register.

12. The method of claim 11, wherein receiving the previous location comprises receiving a previous location estimated by the location register using at least one of a network system identifier, location coordinates of the mobile unit, an estimate of an accuracy of the location coordinates, and a time when the location coordinates were registered with the location register.

13. The method of claim 9, wherein receiving the information indicating the previous location of the mobile unit comprises receiving a message including a flag indicating that the location server was unable to determine the current location of the mobile unit.

14. The method of claim 9, comprising providing, from the location-based application server and to the location server, a request to receive the previous location when the location server is unable to determine the current location of the mobile unit, wherein the request to receive the previous location is provided prior to receiving the request for the current location of the mobile unit.

15. The method of claim 9, comprising providing at least one location-based service to a location-based service client associated with the mobile unit using the previous location of the mobile unit received from the location server.
